(19) United States
(12) Patent Application Publication
(10) Pub. No.: US 2018/0144636 A1
(43) Pub. Date: May 24, 2018

(54) DISTRACTED DRIVER DETECTION, CLASSIFICATION, WARNING, AVOIDANCE SYSTEM

(71) Applicant: Faraday&Future Inc., Gardena, CA (US)

(72) Inventor: Jan Becker, Palo Alto, CA (US)

(21) Appl. No.: 15/639,218

(22) Filed: Jun. 30, 2017

Related U.S. Application Data
(60) Provisional application No. 62/357,299, filed on Jun. 30, 2016.

(51) Int. Cl. G08G 1/16

(52) U.S. Cl. CPC G08G 1/166

(57) ABSTRACT

A system that performs a method is disclosed. The system determines information about the area surrounding a vehicle, which includes information about other vehicles and other drivers. Using this information, the system determines whether there is a distracted driver around the vehicle. In accordance with a determination that there is a distracted driver around the vehicle, the system performs a precautionary action. In accordance with a determination that there is a distracted driver around the vehicle, the system foregoes performing the precautionary action.

### CROSS-REFERENCE TO RELATED APPLICATIONS

This application claims the benefit of U.S. Provisional Application No. 62/357,299, filed Jun. 30, 2016, the entirety of which is hereby incorporated by reference.

### FILED OF THE DISCLOSURE

This relates generally to automatically detecting distracted driver patterns for safe vehicle navigation.

### BACKGROUND OF THE DISCLOSURE

Distracted driving has significantly increased, particularly in light of the wide scale use of smartphones and other mobile devices without proper vehicle integration. Moreover, drunk driving, drowsy driving, speeding, and driving inexperience continue to contribute to vehicle collisions. According to the National Highway Traffic Safety Administration, in 2014, distracted driving was a factor in 10% of crash fatalities, drunk driving was a factor in 31% of crash fatalities, drowsy driving was a factor in 2.6% of crash fatalities, and speeding was a factor in 28% of crash fatalities. (See http://www-nrd.nhtsa.dot.gov/Pubs/812219.pdf.) Therefore, a solution to automatically detect distracted, or otherwise unsafe, drivers for safe vehicle navigation is desirable.

### SUMMARY OF THE DISCLOSURE

Examples of the disclosure are directed to using pattern recognition or other algorithms to automatically recognize distracted (e.g., unsafe) driving behavior for safe vehicle navigation. The vehicle can use unsafe driving patterns to classify another vehicle as being driven by a distracted driver. In this way, the vehicle can automatically warn the driver and/or avoid the other vehicle driven by the distracted, or otherwise unsafe, driver for safe vehicle navigation.

### BRIEF DESCRIPTION OF THE DRAWINGS

FIG. 1 illustrates an exemplary vehicle and another vehicle being driven by a distracted driver according to examples of the disclosure.

FIG. 2 illustrates an exemplary process for classifying distracted drivers for safe navigation according to examples of the disclosure.

FIG. 3 illustrates an exemplary system block diagram of a vehicle control system according to examples of the disclosure.

### DETAILED DESCRIPTION

In the following description of examples, references are made to the accompanying drawings that form a part hereof, and in which it is shown by way of illustration specific examples that can be practiced. It is to be understood that other examples can be used and structural changes can be made without departing from the scope of the disclosed examples.

Some vehicles, such as automobiles, may include various sensors for detecting and gathering information about the vehicles' surroundings, such as information about other vehicles and the other vehicles' drivers. Examples of the disclosure are directed to recognizing distracted driver patterns based on various considerations such as characteristics about other vehicles, characteristics about the drivers of the other vehicles, and characteristics about the vehicle itself, among other considerations. The vehicle can use distracted driving patterns or any other irregular driving patterns to automatically classify another vehicle as being driven by a distracted driver. It is understood that while the examples of the disclosure describe classifying distracted drivers, the teachings of the disclosure analogously extend to classifying any form of irregular driving for safe vehicle navigation. In this way, the vehicle can automatically warn the driver and/or avoid an unsafe vehicle. This can help the vehicle avoid distracted drivers, drunk drivers, drowsy drivers, inexperienced drivers, reckless drivers, or any other form unsafe drivers.

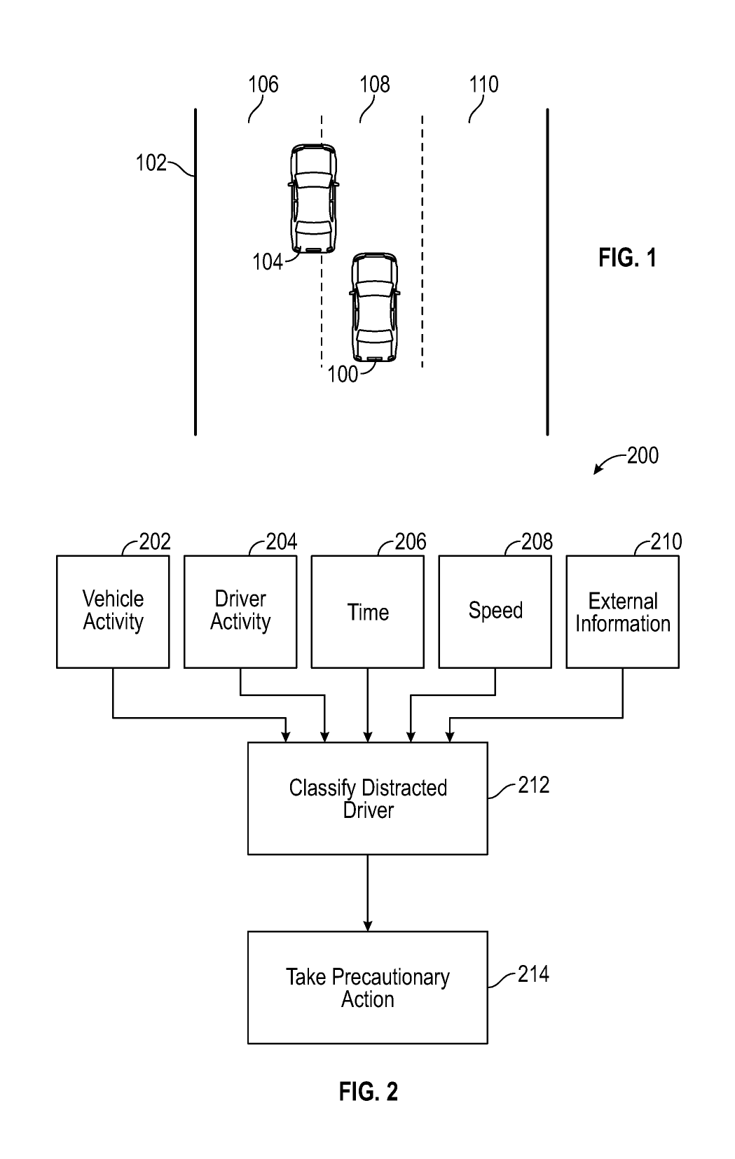

FIG. 1 illustrates exemplary vehicle 100 driving on road 102 according examples of the disclosure. Vehicle 100 can include various sensors and systems for determining one or more characteristics of other vehicles and/or drivers of other vehicles on road 102. These sensors can include ultrasonic sensors, laser sensors, radar sensors, cameras, LIDAR sensors, or any other sensors that can be used to detect one or more characteristics about other vehicles and/or drivers of other vehicles. These sensors can be configured on vehicle 100 to provide it with 360 degree coverage of the area surrounding the vehicle. Vehicle 100 can process data from one or more of these sensors to identify patterns of vehicles being operated by distracted, or otherwise dangerous, drivers. In some examples, vehicle 100 can make such determinations by analyzing another vehicle's (or its driver's) activities. For example, vehicle 100 can automatically determine that vehicle 104 is being operated by a distracted driver after observing that vehicle 104 does not stay in the center of lane 106 or at times partially enters lane 108. Vehicle 100 can be configured to automatically recognize distracted driver patterns through machine learning. For example, the onboard computer of vehicle 100 can be provided with data of vehicles driving erratically (e.g., irregularly). This data can include image data (or video data) of vehicles not staying within their lanes, vehicles driving at night without the headlights turned on, vehicles not using turn signals, vehicles with the hazard lights on, drivers or passengers opening doors, drivers using cell phones, drivers reading books or newspapers, drivers putting on makeup, drivers eating, drivers shaving, drivers looking away from the road (e.g., down into their vehicles, other vehicles, a passenger, etc.), or any other example of distracted or unsafe drivers. This data can also include information about other vehicles' speeds and positions relative to vehicle 100, the time of day, traffic information, etc. The onboard computer of vehicle 100 can also be provided with data of vehicles driving normally (e.g., staying within the center of their lanes, keeping up with the flow of traffic, using turn signals, pulling over for an emergency vehicle, etc.). Machine learning techniques are well known in the art. In some examples, the driver of vehicle 100 can provide feedback to the vehicle's automated distracted driver classifications during driving operations to enhance the system's accuracy in identifying distracted drivers. For example, the driver can confirm or reject a distracted driver classification for additional machine learning. In some examples, the driver can enter this feedback through a control system such as buttons, a touch screen, a computer, a smart phone, or any device or system that allows user input to be entered. In some examples, the driver can manually classify another vehicle has being driven by a distracted driver. In some examples, the known distracted driver patterns can be updated through system updates.

In some examples, vehicle 100 can automatically take precautionary actions after determining that vehicle 104 is being driven by a distracted or unsafe driver. In some examples, vehicle 100 can be driving autonomously and can automatically take steps to avoid getting near vehicle 104 (e.g., without driver input). For example, vehicle 100 can automatically move into lane 110, slow down to create further distance with the other vehicle, safely drive past vehicle 104, stay out of vehicle 104's blind spots, notify the driver or any third party, or allow the driver to take over driving operations. In some examples, vehicle 100 can provide a visual representation of the distracted driver vehicle (during automated and non-automated driving operations). For example, vehicle 100 can be equipped with a windshield heads up display and can project an overlay over vehicle 104 on the windshield (e.g., highlight the vehicle in red or any other color). In some examples, vehicle 100 can provide a visual representation of vehicle 104 in vehicle 100's infotainment system, a smart phone, or any other electronic device with a display. In some examples, vehicle 100 can activate a sound and/or audio indicator signifying that a distracted driver classification has been made.

FIG. 2 illustrates an exemplary process 200 for detecting and avoiding vehicles driven by distracted or unsafe drivers according to examples of the disclosure. Process 200 can be performed continuously or repeatedly by the vehicle during automated and non-automated driving operations.

At 202, the activity of other vehicles can be monitored to recognize distracted, or otherwise dangerous, driver patterns (e.g., as described with reference to FIG. 1). In some examples, the speed and position of other vehicles can be determined using a radar sensor, a LIDAR sensor, or any other sensor on that vehicle that can used to determine the speed and position of other vehicles. For example, the vehicle can analyze another vehicle's speed and position over time, and therefore determine the other vehicle's acceleration and braking patterns. In some examples, this can allow the vehicle to determine, without driver input, whether the other vehicle is accelerating or braking suddenly. In some examples, the vehicle can compare the speed of all the surrounding vehicles to determine whether a vehicle is failing to keep up with the flow of traffic. In some examples, the vehicle can monitor the distance of other vehicles relative to the vehicle. For example, the vehicle can automatically monitor, without driver input, whether the distance between an adjacent vehicle falls below a threshold (e.g., less than one foot). In some examples, the vehicle can determine whether another vehicle is tailgating it (e.g., driving too close to the vehicle such that the distance between the two vehicles does not indicate that the other vehicle would be able to stop to avoid a collision). In some examples, the vehicle can determine if another vehicle is tailgating other vehicles by comparing their relative positions to the vehicle. These determinations can be indications of a distracted driver. The vehicle can keep track of these distracted driver indications, or any other indications that a driver is distracted or otherwise dangerous for each vehicle in the vicinity at 202 (e.g., by counting the indications, measuring the duration of the indications, measuring the frequency of the indications, etc.). In some examples, the vehicle can automatically determine that certain vehicle activity is not indicative of a distracted driver. For example, the vehicle can determine that another vehicle stopping five feet from another vehicle at a stop sign is not an indication of a distracted driver even though the distance between the two vehicles would be considered tailgating if the two vehicles were in motion.

In some examples, the vehicle can monitor the activity of other vehicles using optical cameras. For example, the vehicle can analyze images of other vehicles around it. In some examples, the vehicle can determine whether another vehicle is not staying within the center of its lane. For example, the vehicle can analyze image data (or video data) of another vehicle to determine the distance between the wheels of the other vehicle and the lane dividers on one or both sides of the other vehicle. The vehicle can use this information to monitor the other vehicle's position within the other vehicle's lane over time. This can allow the vehicle to determine, without driver input, whether the driver of the other vehicle allows his or her vehicle to go outside of its driving lane (e.g., drive over or past driving lane dividers). This can also allow the vehicle to automatically determine how frequently the other vehicle is correcting its steering toward the center of its driving lane (e.g., correcting its steering every few seconds, every 10 seconds, etc.). Allowing a vehicle to partially enter an adjacent lane or failing to routinely steer a vehicle toward the center of its driving lane (e.g., not correcting the steering every few seconds, every 10 seconds, etc.) can be indicative of a distracted driver. In some examples, the vehicle can determine if a driver is delayed in moving forward at an intersection after a traffic light changes from red to green. For example, the vehicle can compare image data (or video data) of the other vehicles from when the traffic light is red to image data (or video data) of when the traffic light is green. Using this data, the vehicle can determine, without driver input, how long after an intersection light turns green a particular vehicle's brake lights turn off (indicating a forward motion) and/or compare, without driver input, the position of the other vehicles over time. In some examples, the vehicle can automatically identify when another vehicle turns on its hazard lights. Again, the vehicle can keep track of these distracted driver indications, or any other indications that a driver is distracted or otherwise dangerous for each vehicle in the vicinity at 202 (e.g., by counting the indications, measuring the duration of the indications, measuring the frequency of the indications, etc.). In some examples, the vehicle can automatically determine that vehicle activity is not an indication of a distracted driver. For example, the vehicle can determine that another vehicle changing lanes with its turn signal on is not an indication of a distracted driver even though the other vehicle entered into an adjacent lane. As another example, the vehicle can determine that another vehicle pulling over to allow an emergency vehicle to pass is not an indication of a distracted driver. In some examples, the driver can provide feedback at 202 regarding the vehicle's automated distracted driver determinations during driving operations to enhance the system's accuracy in identifying distracted driver indications (e.g., through machine learning as described with reference to FIG. 1).

At 204, the activity of the drivers of other vehicles can be monitored (e.g., as described with reference to FIG. 1). In some examples, the activity of other drivers can be monitored using an optical camera, an infrared camera, or any other camera, sensor, or system that can capture images of drivers of other vehicles. The vehicle can recognize a distracted driver pattern by comparing image data (or video data) of surrounding drivers to known patterns (e.g., images or videos) of drivers performing activities that are indicative of a distracted driver such as opening doors, using cell phones, reading books or newspapers, putting on makeup, eating, drinking, shaving, looking down into their vehicles, or any other activity that would impair a driver's ability to operate a vehicle safely. In some examples, the vehicle can automatically determine that certain driver activity is not indicative of a distracted driver. For example, the vehicle can determine that another driver looking side-to-side (e.g., from left to right and vice versa) at a two-way stop sign is not indicative of a distracted driver even though the other driver is not facing forward. The known patterns of drivers performing distracted activities can be expanded through system updates and/or further fine-tuned through user feedback (e.g., through machine learning as described with reference to FIG. 1). For example, the user can confirm or reject that an image (or video) of another driver shows that the other driver is distracted. In some examples, the vehicle can track, without driver input, the number of distracted driver indications, or any other indications that a driver is distracted or otherwise dangerous for each vehicle in the vicinity at 204 (e.g., by counting the indications, measuring the duration of the indications, measuring the frequency of the indications, etc.).

At 206, the time of day (or night) can be monitored. In some examples, the time of day can be determined by an internal clock in the vehicle, an external clock, or any other device that can determine the time.

At 208, the speed of the vehicle itself can be monitored (e.g., as described with reference to FIG. 1). In some examples, the speed of the vehicle can be determined using a speed sensor coupled to the wheels of the vehicle, a GPS receiver on the vehicle, or any other sensor on the vehicle that can determine the vehicle's speed.

At 210, additional external information about the vehicles and/or drivers of the vehicles can be monitored. In some examples, the additional external information can include information obtained from other vehicles on the road. For example, a third-party vehicle can monitor, using its own sensors, the activity of itself, the vehicle and its driver, and/or other vehicles and their drivers (as described above), and can communicate that data to other vehicles in the vicinity. For example, the third party vehicle can determine that another vehicle is tailgating it and can communicate that information to other vehicles in the vicinity. In some examples, the third-party vehicle can communicate its distracted driver classifications to other vehicles. For example, the third party vehicle can determine that another vehicle, or even the third party vehicle itself, is being driven in an unsafe manner (as described above) and can communicate that information to other vehicles in the vicinity. In this way, the vehicle can use the data from other vehicles' sensors and the classifications from other vehicles as input to make its own distracted driver classifications. In some examples, the additional external information can include information from stationary sensors along roads or at intersections. These stationary sensors can include ultrasonic sensors, laser sensors, radar sensors, cameras, LIDAR sensors, or any other sensors that can be used to detect one or more characteristics about vehicles and/or drivers. These stationary sensors can be configured as on-site or remote systems for detecting distracted, or otherwise dangerous, drivers. These on-site or remote systems can be configured to communicate information about distracted, or otherwise dangerous, drivers to vehicles and/or drivers within the vicinity of the stationary sensors. These on-site or remote systems can also be configured to communicate information about distracted, or otherwise dangerous, drivers to the police, medical personnel, or any third party.

At 212, the vehicle can autonomously make a distracted driver classification without driver input based on the results of one or more steps 202, 204, 206, 208, and 210 (e.g., as described with reference to FIG. 1). In some examples, this classification can be made if the number of distracted driver indications from one or more steps 202, 204, and/or 210 is above a threshold (e.g., more than five distracted driver indications in the last ten minutes). In some examples, this classification at 212 can include combining and analyzing the results of one or more steps 202, 204, 206, 208, and 210. For example, the vehicle can combine one or more distracted driver indications from step 202 and/or step 204 with the time of day from step 206 to make a distracted driver classification. In this way, the vehicle can combine a determination that another vehicle partially entered an adjacent lane once in the last ten minutes with the fact that the current time is between midnight and 4 a.m. to make the classification, without driver input, that the other driver of the other vehicle is distracted (e.g., under the influence or drowsy). In some examples, the vehicle can determine whether another vehicle is distracted by comparing that particular vehicle's driving patterns to the average driving patterns of other vehicles (e.g., the average actions of the other vehicles on the same road) or the driving patterns of the vehicle itself. For example, the vehicle can compare the speed of another vehicle to the speed of other vehicles on the road (and/or its own speed) to determine that the speed of that vehicle is above a threshold speed (e.g., more than 10 miles-per-hour than the average speed of other vehicles or more than 10 miles-per-hour than the vehicle) to make the classification that the other driver is distracted or otherwise dangerous. In another example, the vehicle can compare the speed of another vehicle to the speed of other vehicles on the road (and/or its own speed) to determine that the speed of that vehicle is below a threshold speed (e.g., less than 10 miles-per-hour than the average speed of the other vehicles or less than 10 miles-per-hour than the speed of the vehicle) to make the classification that the driver is distracted or otherwise unsafe. In some examples, the vehicle can combine the determination that another vehicle is traveling five miles-per-hour slower than the vehicle with the observation that the driver is looking at a smartphone to make the classification that the driver is distracted. In some examples, the driver of vehicle 100 can provide feedback to the vehicle's distracted driver classifications during driving operations to enhance the system's accuracy in recognizing distracted drivers (e.g., through machine learning as discussed with reference to FIG. 1).

At 214, a precautionary action can automatically be taken based on the distracted driver classification at 212 (e.g., as described with reference to FIG. 1). In some examples, the precautionary action can include avoiding getting close to another vehicle with a distracted driver when the vehicle is operating autonomously. Avoiding the other vehicle can include automatically slowing down to increase the vehicle's distance to the distracted driver vehicle (e.g., to more than two car spaces), safely driving past the distracted driver vehicle, changing lanes, or staying out of the distracted driver vehicle's blind spots. In some examples, the precautionary action can include changing the modes of driving operation (e.g., automated driving mode, assisted driving mode, and manual driving mode). For example, the vehicle can be operating in an automated driving mode (e.g., driving autonomously without user input) when the vehicle makes a distracted driver classification and the vehicle can change the mode of operation to a manual driving mode (e.g., allow the driver to take over driving operations) or an assisted driving mode (e.g., to automatically change lanes, slow down, pull over, or perform any other automated driving operation). In another example, the vehicle can be operating in a manual driving mode when the vehicle makes a distracted driver classification and the vehicle can change the mode of operation to an automated driving mode or an assisted driving mode. In another example, the vehicle can be operating in an assisted driving mode when the vehicle makes a distracted driver classification and the vehicle can change the mode of operation to an automated driving mode or a manual driving mode. In some examples, the precautionary action can include notifying the driver, the distracted driver, or any designated third party (whether or not the vehicle is being driven autonomously). The notification can be a phone call, text message, email, or any form of electronic or audible/visual communication to an electronic device associated with the third party (e.g., smartphone or other electronic device) or to another human being. The designated third party can be the vehicle's owner, a call center, a 911 operator, and/or any other third party. In some examples, the vehicle can provide a visual representation of the distracted vehicle. For example, the vehicle can be equipped with a windshield heads up display and can project an overlay over the vehicle being driven by the distracted driver (e.g., highlight the vehicle in red or any other color). In some examples, the vehicle can provide a visual representation of the vehicle being driven by the distracted driver in the vehicle's infotainment system, a smart phone, or any other electronic device with a display. In some examples, the vehicle can activate visual and/or audio indicators that a distracted driver classification was made. Visual indicators can include one or more of a headlight, a hazard light, a smog light, or any light source on the outside or the inside of the vehicle. The audio indicators can include one or more of a horn, a speaker, an alarm system, and/or any other sound source in the vehicle. In some examples, the visual and/or audio indicators can intensify (e.g., get louder, increase frequency, etc.) as the distance between the vehicle and the distracted driver decreases. In some examples, the vehicle can attempt to notify the distracted driver of his distractedness with these visual and/or audio indicators.

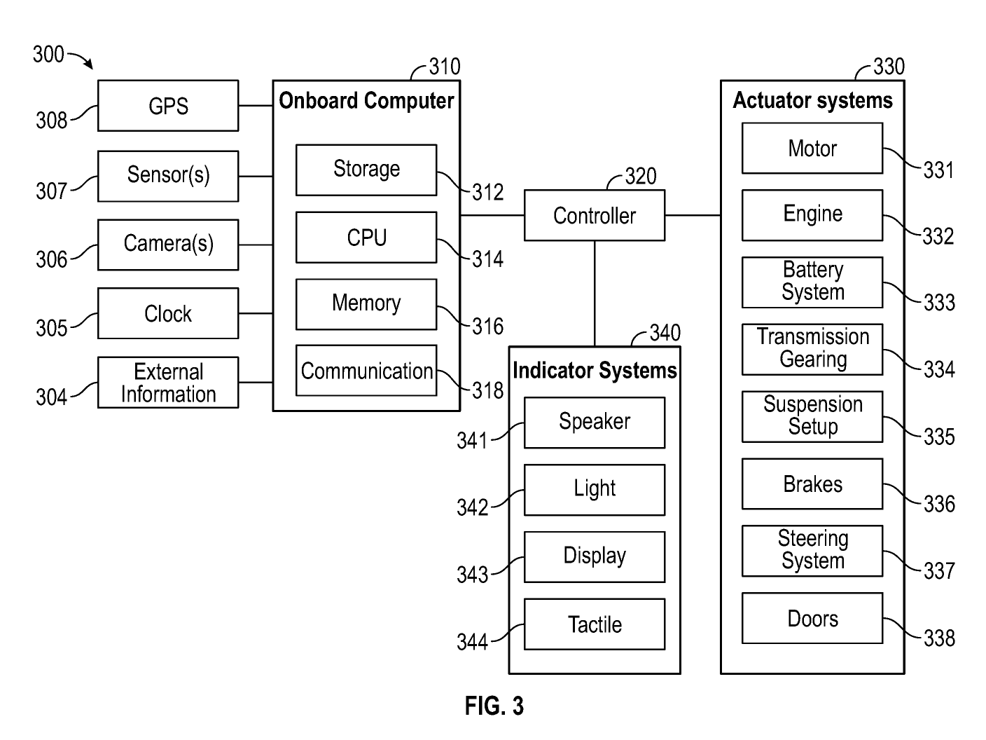

FIG. 3 illustrates an exemplary system block diagram of vehicle control system 300 according to examples of the disclosure. Vehicle control system 300 can perform any of the methods described with reference to FIGS. 1 and 2. System 300 can be incorporated into a vehicle, such as a consumer automobile. Other example vehicles that may incorporate the system 300 include, without limitation, airplanes, boats, or industrial automobiles. Vehicle control system 300 can include one or more cameras 306 capable of capturing image data (e.g., video data) for determining various characteristics of other vehicles and/or drivers of other vehicles, as described with reference to FIGS. 1 and 2. Vehicle control system 300 can also include one or more other sensors 307 (e.g., radar, ultrasonic, LIDAR, etc.) capable of detecting various characteristics of other vehicles and/or drivers of other vehicles, and a Global Positioning System (GPS) receiver 308 capable of determining the location and/or speed of the vehicle. The characteristics of other vehicles and/or drivers of other vehicle can help determine whether a driver of another vehicle is distracted (e.g., as described above with references to FIGS. 1 and 2). Vehicle control system 300 can also include clock 305 capable of determining the current time. Vehicle control system 300 can also receive (e.g., via an internet connection) additional external information of other vehicles and/or drivers of other vehicles via an external information interface 304 (e.g., a cellular internet interface, a Wi-Fi internet interface, etc.).

Vehicle control system 300 can include an on-board computer 310 that is coupled to the cameras 306, sensors 307, GPS receiver 308, clock 305, and external information interface 304, and that is capable of receiving the image data from the cameras and/or outputs from the sensors 307, the GPS receiver 308, clock 305, and external information interface 304. The on-board computer 310 can be capable of determining whether the driver of another vehicle is distracted, or otherwise dangerous, as described in this disclosure. On-board computer 310 can include storage 312, memory 316, communications interface 318, and processor 314. Processor 314 can perform any of the methods described with reference to FIGS. 1 and 2. Additionally, communications interface 318 can perform any of the communication actions described with reference to FIGS. 1 and 2. For example, communications interface 318 can send vehicle and/or driver data to the driver, other vehicles, or any third party. Moreover, storage 312 and/or memory 316 can store data and instructions for performing any of the methods described with reference to FIGS. 1 and 2. Storage 312 and/or memory 316 can be any non-transitory computer readable storage medium, such as a solid-state drive or a hard disk drive, among other possibilities. The vehicle control system 300 can also include a controller 320 capable of controlling one or more aspects of vehicle operation, such as performing autonomous driving operations using distracted driver determinations by the on-board computer 310.

In some examples, the vehicle control system 300 can be connected to (e.g., via controller 320) one or more actuator systems 330 in the vehicle and one or more indicator systems 340 in the vehicle. The one or more actuator systems 330 can include, but are not limited to, a motor 331 or engine 332, battery system 333, transmission gearing 334, suspension setup 335, brakes 336, steering system 337, and door system 338. The vehicle control system 300 can control, via controller 320, one or more of these actuator systems 330 during vehicle operation; for example, to control the vehicle during autonomous driving operations, which can utilize the distracted driver classifications by the on-board computer 310, using the motor 331 or engine 332, battery system 333, transmission gearing 334, suspension setup 335, brakes 336, and/or steering system 337, etc. Actuator systems 330 can also include sensors that send dead reckoning information (e.g., steering information, speed information, etc.) to on-board computer 310 (e.g., via controller 320). The one or more indicator systems 340 can include, but are not limited to, one or more speakers 341 in the vehicle (e.g., as part of an entertainment system in the vehicle), one or more lights 342 in the vehicle, one or more displays 343 in the vehicle (e.g., as part of a control, entertainment, heads up display system(s) in the vehicle), and one or more tactile actuators 344 in the vehicle (e.g., as part of a steering wheel or seat in the vehicle). The vehicle control system 300 can control, via controller 320, one or more of these indicator systems 340 to provide visual and/or audio indications that a distracted, or otherwise dangerous, driver was classified.

Thus, the examples of the disclosure provide various ways to utilize a vehicle's automated distracted (e.g., unsafe) driver classifications to safely navigate the vehicle autonomously or manually.

Therefore, according to the above, some examples of the disclosure are directed to a system comprising: one or more sensors; one or more processors coupled to the one or more sensors; and a memory including instructions, which when executed by the one or more processors, cause the one or more processors to perform a method comprising: determining one or more characteristics about an area surrounding a vehicle using the one or more sensors; determining whether the one or more characteristics about the area surrounding the vehicle is indicative of a distracted driver; wherein: the one or more characteristics about the area surrounding the vehicle comprises one or more of: one or more characteristics about one or more other vehicles; one or more characteristics about one or more other drivers; and in response to determining whether the one or more characteristics about the area surrounding the vehicle is indicative of the distracted driver: in accordance with a determination that the one or more characteristics about the area surrounding the vehicle is indicative of the distracted driver, performing a precautionary action; and in accordance with a determination that the one or more characteristics about the area surrounding the vehicle is not indicative of the distracted driver, foregoing performing the precautionary action. Additionally or alternatively to one or more of the examples disclosed above, in some examples, the one or more characteristics about the one or more other vehicles comprises the one or more other vehicles partially entering into an adjacent driving lane without a turn signal; and partially entering into the adjacent driving lane without the turn signal is indicative of the distracted driver. Additionally or alternatively to one or more of the examples disclosed above, in some examples, the one or more characteristics about one or more other vehicles comprises the one or more other vehicles failing to routinely steer the one or more other vehicles toward the center of its driving lane; and failing to routinely steer the one or more other vehicles toward the center of its driving lane is indicative of the distracted driver. Additionally or alternatively to one or more of the examples disclosed above, in some examples, the one or more characteristics about the one or more other vehicles comprises the one or more other vehicles failing to keep up with the flow of traffic; and failing to keep up with the flow of traffic is indicative of the distracted driver. Additionally or alternatively to one or more of the examples disclosed above, in some examples, the one or more characteristics about the one or more other vehicles comprises the one or more other vehicles accelerating or braking suddenly; and accelerating or braking suddenly is indicative of the distracted driver. Additionally or alternatively to one or more of the examples disclosed above, in some examples, the one or more characteristics about the one or more other vehicles comprises the one or more other vehicles having hazard lights on; and having hazard lights on is indicative of the distracted driver. Additionally or alternatively to one or more of the examples disclosed above, in some examples, the one or more characteristics about the one or more other vehicles comprises the one or more other vehicles traveling at a speed equal to or above a first threshold speed; and traveling at the speed equal to or above the first threshold speed is indicative of the distracted driver. Additionally or alternatively to one or more of the examples disclosed above, in some examples, the one or more characteristics about the one or more other vehicles comprises the one or more other vehicles traveling at a speed equal to or below a second threshold speed; and traveling equal to or below the second threshold speed is indicative of the distracted driver. Additionally or alternatively to one or more of the examples disclosed above, in some examples, the one or more characteristics about the one or more other vehicles comprises the one or more other vehicles traveling at a speed between the first threshold speed and the second threshold speed; and traveling at the speed between the first threshold speed and the second threshold speed is not indicative of the distracted driver. Additionally or alternatively to one or more of the examples disclosed above, in some examples, the one or more characteristics about the one or more other vehicles comprises the one or more other vehicles tailgating the vehicle or another vehicle; and tailgating the vehicle or another vehicle is indicative of the distracted driver. Additionally or alternatively to one or more of the examples disclosed above, in some examples, the one or more characteristics about the one or more other drivers comprises one or more of opening a door, using a cell phone, reading a book, reading a newspaper, putting on makeup, eating, shaving, and looking away; and opening a door, using a cell phone, reading a book, reading a newspaper, putting on makeup, eating, shaving, and looking away are each indicative of the distracted driver. Additionally or alternatively to one or more of the examples disclosed above, in some examples, the precautionary action comprises one or more of slowing the vehicle down, driving past the one or more other vehicles, navigating the vehicle to a different driving lane, staying out of the one or more other vehicles' blind spots, and notifying a third party. Additionally or alternatively to one or more of the examples disclosed above, in some examples, the precautionary action further comprises providing a visual representation of the one or more other vehicles. Additionally or alternatively to one or more of the examples disclosed above, in some examples, the precautionary action further comprises activating an indicator in the vehicle. Additionally or alternatively to one or more of the examples disclosed above, in some examples, the indicator is one or more of a headlight, a hazard light, a smog light, a horn, a speaker, and an alarm system in the vehicle. Additionally or alternatively to one or more of the examples disclosed above, in some examples, the one or more characteristics about the area surrounding the vehicle is received from an external source. Additionally or alternatively to one or more of the examples disclosed above, in some examples, the external source comprises one or more of: the one or more other vehicles; and one or more stationary sensors. Additionally or alternatively to one or more of the examples disclosed above, in some examples, the one or more characteristics about the area surrounding the vehicle further comprises a time. Additionally or alternatively to one or more of the examples disclosed above, in some examples, determining the one or more characteristics about the area surrounding the vehicle using the one or more sensors occurs while operating the vehicle in a mode of vehicle operation, wherein the mode of vehicle operation comprises one of: an automated driving mode; an assisted driving mode; and a manual driving mode. Additionally or alternatively to one or more of the examples disclosed above, in some examples, the precautionary action further comprises changing the mode of vehicle operation. Additionally or alternatively to one or more of the examples disclosed above, in some examples, determining whether the one or more characteristics about the area surrounding the vehicle is indicative of the distracted driver comprises: maintaining a count of the one or more characteristics about the area surrounding the vehicle that are indicative of another vehicle being driven by an unsafe driver; determining whether the count of the one or more characteristics about the area surrounding the vehicle that are indicative of another vehicle being driven by the unsafe driver is equal to or above a threshold; and in response to determining whether the count of the one or more characteristics about the area surrounding the vehicle that are indicative of another vehicle being driven by the unsafe driver is equal to or above the threshold: in accordance with a determination that the count of the one or more characteristics about the area surrounding the vehicle that are indicative of another vehicle being driven the unsafe driver is equal to or above the threshold, performing the precautionary action; and in accordance with a determination that the count of the one or more characteristics about the area surrounding the vehicle that are indicative of another vehicle being driven the unsafe driver is not equal to or above the threshold, foregoing performing the precautionary action. Additionally or alternatively to one or more of the examples disclosed above, in some examples, determining whether the one or more characteristics about the area surrounding the vehicle is indicative of the distracted driver comprises: determining an average one or more characteristics about one or more other vehicles; and comparing the one or more characteristics about one or more other vehicles to the average one or more characteristics about one or more other vehicles.

Some examples of the disclosure are directed to a non-transitory computer-readable medium including instructions, which when executed by one or more processors, cause the one or more processors to perform a method comprising: determining one or more characteristics about an area surrounding a vehicle using one or more sensors; determining whether the one or more characteristics about the area surrounding the vehicle is indicative of a distracted driver; wherein: the one or more characteristics about the area surrounding the vehicle comprises one or more of: one or more characteristics about one or more other vehicles; one or more characteristics about one or more other drivers; and in response to determining whether the one or more characteristics about the area surrounding the vehicle is indicative of the distracted driver: in accordance with a determination that the one or more characteristics about the area surrounding the vehicle is indicative of the distracted driver, performing a precautionary action; and in accordance with a determination that the one or more characteristics about the area surrounding the vehicle is not indicative of the distracted driver, foregoing performing the precautionary action.

Some examples of the disclosure are directed to a vehicle comprising: one or more sensors; one or more processors; and a memory including instructions, which when executed by the one or more processors, cause the one or more processors to perform a method comprising: determining one or more characteristics about an area surrounding the vehicle using one or more sensors; determining whether the one or more characteristics about the area surrounding the vehicle is indicative of a distracted driver; wherein: the one or more characteristics about the area surrounding the vehicle comprises one or more of: one or more characteristics about one or more other vehicles; one or more characteristics about one or more other drivers; and in response to determining whether the one or more characteristics about the area surrounding the vehicle is indicative of the distracted driver: in accordance with a determination that the one or more characteristics about the area surrounding the vehicle is indicative of the distracted driver, performing a precautionary action; and in accordance with a determination that the one or more characteristics about the area surrounding the vehicle is not indicative of the distracted driver, foregoing performing the precautionary action.

Some examples of the disclosure are directed to a method comprising: determining one or more characteristics about an area surrounding a vehicle using one or more sensors; determining whether the one or more characteristics about the area surrounding the vehicle is indicative of a distracted driver; wherein: the one or more characteristics about the area surrounding the vehicle comprises one or more of: one or more characteristics about one or more other vehicles; one or more characteristics about one or more other drivers; and in response to determining whether the one or more characteristics about the area surrounding the vehicle is indicative of the distracted driver: in accordance with a determination that the one or more characteristics about the area surrounding the vehicle is indicative of the distracted driver, performing a precautionary action; and in accordance with a determination that the one or more characteristics about the area surrounding the vehicle is not indicative of the distracted driver, foregoing performing the precautionary action.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
one or more sensors;
one or more processors coupled to the one or more sensors; and
a memory including instructions, which when executed by the one or more processors, cause the one or more processors to perform a method comprising:
determining one or more characteristics about an area surrounding a vehicle using the one or more sensors;
determining whether the one or more characteristics about the area surrounding the vehicle is indicative of a distracted driver; wherein:
the one or more characteristics about the area surrounding the vehicle comprises one or more of:
one or more characteristics about one or more other vehicles;
one or more characteristics about one or more other drivers; and
in response to determining whether the one or more characteristics about the area surrounding the vehicle is indicative of the distracted driver:
in accordance with a determination that the one or more characteristics about the area surrounding the vehicle is indicative of the distracted driver, performing a precautionary action; and
in accordance with a determination that the one or more characteristics about the area surrounding the vehicle is not indicative of the distracted driver, foregoing performing the precautionary action.

2. The system of claim 1, wherein:
the one or more characteristics about the one or more other vehicles comprises the one or more other vehicles partially entering into an adjacent driving lane without a turn signal; and
partially entering into the adjacent driving lane without the turn signal is indicative of the distracted driver.

3. The system of claim 1, wherein:
the one or more characteristics about one or more other vehicles comprises the one or more other vehicles failing to routinely steer the one or more other vehicles toward the center of its driving lane; and
failing to routinely steer the one or more other vehicles toward the center of its driving lane is indicative of the distracted driver.

4. The system of claim 1, wherein:
the one or more characteristics about the one or more other vehicles comprises the one or more other vehicles failing to keep up with the flow of traffic; and
failing to keep up with the flow of traffic is indicative of the distracted driver.

5. The system of claim 1, wherein:
the one or more characteristics about the one or more other vehicles comprises the one or more other vehicles accelerating or braking suddenly; and
accelerating or braking suddenly is indicative of the distracted driver.

6. The system of claim 1, wherein:
the one or more characteristics about the one or more other vehicles comprises the one or more other vehicles having hazard lights on; and
having hazard lights on is indicative of the distracted driver.

7. The system of claim 1, wherein:
the one or more characteristics about the one or more other vehicles comprises the one or more other vehicles traveling at a speed equal to or above a first threshold speed; and
traveling at the speed equal to or above the first threshold speed is indicative of the distracted driver.

8. The system of claim 7, wherein:
the one or more characteristics about the one or more other vehicles comprises the one or more other vehicles traveling at a speed equal to or below a second threshold speed; and
traveling equal to or below the second threshold speed is indicative of the distracted driver.

9. The system of claim 8, wherein:
the one or more characteristics about the one or more other vehicles comprises the one or more other vehicles traveling at a speed between the first threshold speed and the second threshold speed; and
traveling at the speed between the first threshold speed and the second threshold speed is not indicative of the distracted driver.

10. The system of claim 1, wherein:
the one or more characteristics about the one or more other drivers comprises one or more of opening a door, using a cell phone, reading a book, reading a newspaper, putting on makeup, eating, shaving, and looking away; and
opening a door, using a cell phone, reading a book, reading a newspaper, putting on makeup, eating, shaving, and looking away are each indicative of the distracted driver.

11. The system of claim 1, wherein the precautionary action comprises one or more of slowing the vehicle down, driving past the one or more other vehicles, navigating the vehicle to a different driving lane, staying out of the one or more other vehicles' blind spots, and notifying a third party.

12. The system of claim 11, wherein the precautionary action further comprises providing a visual representation of the one or more other vehicles.

13. The system of claim 11, wherein the precautionary action further comprises activating an indicator in the vehicle.

14. The system of claim 1, wherein the one or more characteristics about the area surrounding the vehicle is received from an external source, wherein the external source comprises one or more of:
the one or more other vehicles; and
one or more stationary sensors.

15. The system of claim 1, wherein the one or more characteristics about the area surrounding the vehicle further comprises a time.

16. The system of claim 1, wherein determining the one or more characteristics about the area surrounding the vehicle using the one or more sensors occurs while operating the vehicle in a mode of vehicle operation, wherein the mode of vehicle operation comprises one of:
an automated driving mode;
an assisted driving mode; and
a manual driving mode.

17. The system of claim 16, wherein the precautionary action further comprises changing the mode of vehicle operation.

18. The system of claim 1, wherein:
determining whether the one or more characteristics about the area surrounding the vehicle is indicative of the distracted driver comprises:
maintaining a count of the one or more characteristics about the area surrounding the vehicle that are indicative of another vehicle being driven by an unsafe driver;
determining whether the count of the one or more characteristics about the area surrounding the vehicle that are indicative of another vehicle being driven by the unsafe driver is equal to or above a threshold; and
in response to determining whether the count of the one or more characteristics about the area surrounding the vehicle that are indicative of another vehicle being driven by the unsafe driver is equal to or above the threshold:
in accordance with a determination that the count of the one or more characteristics about the area surrounding the vehicle that are indicative of another vehicle being driven the unsafe driver is equal to or above the threshold, performing the precautionary action; and
in accordance with a determination that the count of the one or more characteristics about the area surrounding the vehicle that are indicative of another vehicle being driven the unsafe driver is not equal to or above the threshold, foregoing performing the precautionary action.

19. A vehicle comprising:
one or more sensors;
one or more processors; and
a memory including instructions, which when executed by the one or more processors, cause the one or more processors to perform a method comprising:
determining one or more characteristics about an area surrounding the vehicle using one or more sensors;
determining whether the one or more characteristics about the area surrounding the vehicle is indicative of a distracted driver; wherein:
the one or more characteristics about the area surrounding the vehicle comprises one or more of:
one or more characteristics about one or more other vehicles;
one or more characteristics about one or more other drivers; and
in response to determining whether the one or more characteristics about the area surrounding the vehicle is indicative of the distracted driver:
in accordance with a determination that the one or more characteristics about the area surrounding the vehicle is indicative of the distracted driver, performing a precautionary action; and
in accordance with a determination that the one or more characteristics about the area surrounding the vehicle is not indicative of the distracted driver, foregoing performing the precautionary action.

20. The vehicle of claim 19, wherein:
the one or more characteristics about the one or more other vehicles comprises the one or more other vehicles partially entering into an adjacent driving lane without a turn signal; and
partially entering into the adjacent driving lane without the turn signal is indicative of the distracted driver.
